(19) United States
(12) Patent Application Publication
(10) Pub. No.: US 2016/0172078 A1
(43) Pub. Date: Jun. 16, 2016

(54) Coaxial Cable

(71) Applicant: JUNKOSHA INC., Kasama-shi (JP)

(72) Inventor: Suguru Tanabe, Kasama-shi (JP)

(21) Appl. No.: 14/908,218

(22) PCT Filed: Jul. 29, 2014
(86) PCT No.: PCT/JP2014/069977

§ 371 Date: Jan. 28, 2016

(30) Foreign Application Priority Data
Jul. 31, 2013 (JP) 2013-159550

(51) Int. Cl. H01B 7/30; H01B 11/18; H01B 1/02

(52) U.S. Cl. CPC H01B 7/303; H01B 1/026; H01B 11/1826

(57) ABSTRACT

A coaxial multicore cable having excellent electrical and slide-resistance characteristics has an inner conductor 11; a dielectric layer 12 disposed on the outer circumferential surface of the inner conductor 11; a tape member 15 having a band-shaped base 16 and an electrical-field-shielding layer 17 disposed on one surface of the base 16, the tape member 1.5 being wrapped around the outer circumferential surface of the dielectric layer 12 such that the base 16 contacts the dielectric layer 12; and a plurality of leads 13 for outer conductors disposed such that at least a portion of the leads 13 contacts the electrical-field-shielding layer 17, the resistance value of the electrical-field-shielding layer 17 being 500 Ω/m or higher.

### FIELD OF THE DISCLOSURE

The present disclosure relates to a coaxial cable, more specifically, an extremely fine coaxial cable.

### DESCRIPTION OF THE RELATED ART

It has been known that an extremely fine coaxial cable is used as a signal line of a medical cable such as an endoscope or an ultrasonic wave probe cable, to transmit high frequency signals through an extremely fine transmission line. A coaxial cable is formed of an inner conductor, a dielectric layer disposed on an outer circumferential surface of the inner conductor, and an outer conductor disposed on an outer circumferential surface of the dielectric layer. Typically, when using a coaxial cable, the outer conductor is grounded at an end of the coaxial cable. The outer conductor of the coaxial cable are formed either by weaving and braiding a plurality of leads for outer conductors, or by spirally wrapping or cross-winding the plurality of leads for outer conductors. The outer conductor, formed either by braiding or cross-winding, is disposed along the outer circumferential surface of the dielectric layer which is disposed on the outer circumferential surface of the inner conductor. A coaxial cable used in a medical cable is required to have flexibility resistance as a characteristic of its use, and furthermore, to have a further reduced diameter for improvement of handling characteristics. Therefore, studies have been conducted to further reduce the diameter of a coaxial cable without degrading its transmission characteristics.

Patent Literature 1 describes that, by forming a metal layer on an outer circumferential surface of a dielectric layer instead of the outer conductor formed in the extremely fine coaxial cable by braiding or cross-winding, it is possible to provide an extremely fine coaxial cable having a high shield performance in spite of the thinness of the shield. The metal layer of the coaxial cable disclosed in Patent Literature 1 is formed by vapor deposition and plating, and has a thickness of 0.1 μm˜20 μm.

In the coaxial cable disclosed in Patent Literature 1, by forming the outer conductor with metal deposition, a diameter of the cable can be reduced as much as the reduced diameter of the leads for outer conductor, without deteriorating the shield performance. However, in the coaxial cable disclosed in Patent Literature 1, when the coaxial cable repeats bending motion, cracking occurs in a metal layer formed on the outer circumferential surface of the dielectric layer, which is likely to further deteriorate the transmission characteristics of the coaxial cable. That is, with the coaxial cable disclosed in Patent Literature 1, there is a problem that sufficient flexibility resistance cannot be obtained.

Further, a coaxial cable having a metal layer-attached tape, in which a metal layer is formed on one surface of a plastic tape, disposed on an outer circumferential surface of a dielectric layer has been known. When the dielectric layer of a coaxial cable has a large diameter, the contour of an effective dielectric material, which includes a gap portion between the dielectric material and the leads for outer conductors, and the dielectric material, may be considered as a substantially cylindrical shape having its center on the same axis as the inner conductor. However, as the outer diameter of the coaxial cable is continuously narrowed for the reduction of the entire diameter, and becomes narrow enough to fall within a range such that it is referred to as an extremely fine cable, the contour of the aforementioned effective dielectric material can no longer be considered as a substantially cylindrical shape. For this reason, the transmission characteristics may be deteriorated. A coaxial cable disclosed in Patent Literature 2 includes a metal layer-attached plastic tape wrapped around an outer circumferential surface of a dielectric layer, such that the metal layer is provided on the surface of the dielectric layer, and a plurality of leads for outer conductors disposed on an outer circumferential surface of the metal layer-attached plastic tape. The coaxial cable disclosed in Patent Literature 2 seems to be capable of suppressing the deterioration of the transmission characteristics, since the contour of an effective dielectric material, which includes a gap portion between the dielectric material and the leads for outer conductors, and the dielectric material, is corrected into a substantially cylindrical shape by the metal layer of the metal layer-attached plastic tape.

In Paragraph [0006] of Patent Literature 2, it is disclosed that “to obtain sufficient skin effect from a metal layer formed of copper or silver, a thickness of at least 2 μm at a high frequency of 1 GHz is required, and a thickness of at least 1 μm at a high frequency of 5 GHz is required; however, it is difficult to increase the thickness of the metal layer by vapor deposition, resulting in a disadvantage where sufficient electrical properties cannot be exhibited.” The reason of increasing the thickness of the metal layer of the coaxial cable disclosed in Patent Literature 2 is to have the metal layer of the metal layer-attached plastic tape function as a conductor. For this reason, in Patent Literature 2, the thickness of the metal layer of the metal layer-attached plastic tape of the coaxial cable is set to be 1 μm or bigger and 4 μm or smaller.

Further, in Paragraph [0013] of Patent Literature 2, it is disclosed that “it is desirable to set a size of an inner conductor to 40 AWG˜28 AWG (external diameter to about 0.08˜0.32 mm) in a coaxial cable adopting this disclosure.” Generally, a cable having an inner conductor size of 32 AWG or bigger is called a small-diameter cable, and a cable having an inner conductor size of 38 AWG or bigger is called an extremely fine cable.

### PRIOR ART

### Patent Literature

Patent Literature 1: Japanese Patent Application Laid-open Publication No. 2006-040806
Patent Literature 2: Japanese Patent Application Laid-open Publication No. 2003-257257

### SUMMARY OF THE DISCLOSURE

### Technical Problem to be Solved

In the structure of the coaxial cable disclosed in Patent Literature 2, the metal layer of the metal layer-attached plastic tape functions as a conductor since it is thick and has a low resistance value. When high frequency signals are transmitted through this coaxial cable, due to skin effect, the transmission signals flows through the metal layer of the metal layer-attached plastic tape, which is provided on an inner side of the outer conductor, but not through the outer conductor formed of the plurality of leads. Since the transmission signals flow through the metal layer of the metal layer-attached plastic tape, but not through the outer conductor having a relatively low resistance value, a loss of signal transmission due to resistance loss may be increased.

To reduce the loss of signal transmission in the coaxial cable having the structure disclosed in Patent Literature 2, further increasing the thickness of the metal layer of the metal layer-attached plastic tape to reduce the resistance value can be considered. However, when the film thickness of the metal layer of the metal layer-attached plastic tape is increased, there is a possibility that flexibility and durability of the coaxial cable may be degraded.

Further, in the extremely fine coaxial cable, in order for the transmission signals to flow through the outer conductor, without the metal layer between the dielectric layer and the outer conductor, deterioration of the transmission characteristics caused by the gap between the dielectric layer and the outer conductor will become a problem. That is, in the extremely fine coaxial cable, a difference between the gauge of the leads for outer conductors and the outer diameter of the dielectric layer is reduced, and a shape of the effective dielectric material including the gap between the dielectric layer and the leads for outer conductors is no longer substantially cylindrical, and thereby a reflection may occur due to a difference between the dielectric permittivity of the air filled in the gap and the dielectric permittivity of the material that forms the dielectric layer, which may in result cause deterioration of the transmission characteristics of the coaxial cable.

An object of the present disclosure is to provide an extremely fine coaxial cable having a low insertion loss and capable of suppressing deterioration of the transmission characteristics when high frequency signals are transmitted.

### Means for Solving the Technical Problem

A coaxial cable according to the present disclosure comprises: an inner conductor; a dielectric layer disposed on an outer circumferential surface of the inner conductor; a tape member having a band-shaped base and an electrical-field-shielding layer disposed on one surface of the base, the tape member wrapped around an outer circumferential surface of the dielectric layer such that the base contacts the dielectric layer; and a plurality of leads for outer conductors disposed such that at least a portion of the leads contacts the electrical-field-shielding layer. A resistance value of the electrical-field-shielding layer is 500 Ω/m or higher.

Since the resistance value of the electrical-field-shielding layer of the coaxial cable according to the present disclosure is 500 Ω/m or higher, the electrical-field-shielding layer does not function as a conductor even when high frequency signals are transmitted, and skin effect prevents transmission signals from flowing into the electrical-field-shielding layer, so that most of the transmission signals may flow into the leads for outer conductors which is in contact with the electrical-field-shielding layer. As a result, the electrical-field-shielding layer does not function as the outer conductor. Therefore, when the signals flow into the electrical-field-shielding layer, it is possible to suppress the loss of signal transmission which may be caused by the resistance component of the electrical-field-shielding layer. Further, in the coaxial cable according to the present disclosure, the electrical-field-shielding layer provided between the dielectric layer and the outer conductor is extremely thin, such that the high resistance value allows little or no flow of transmission signals therein; however, by disposing the leads for outer conductors to contact the dielectric layer, it is possible to exhibit the function of correcting the shape of the effective dielectric material including a gap between the above-described dielectric layer and leads for outer conductors to a cylindrical shape. With this, good transmission characteristics can be obtained without being affected by the gap between the dielectric layer and the outer conductor.

The resistance value of the electrical-field-shielding layer of the coaxial cable according to the present disclosure is preferably 12 kΩ/m or lower.

Since the resistance value of the electrical-field-shielding layer of the coaxial cable according to the present disclosure is 12 kΩ/m or lower, it is possible to exhibit the function of correcting the shape of the effective dielectric material to a cylindrical shape, and to suppress the influence of the gap between the dielectric layer and the outer conductor.

Further, a thickness of the electrical-field-shielding layer of the coaxial cable according to the present disclosure is preferably 0.02 μm or thicker and 0.3 μm or thinner.

Since the thickness of the electrical-field-shielding layer of the coaxial cable according to the present disclosure is 0.02 μm or thicker, the entire electrical-field-shielding layer may be configured to have a substantially even thickness. Further, since the thickness of the electrical-field-shielding layer of the coaxial cable according to the present disclosure is 0.3 μm or thinner, when an extremely fine leads of 38 AWG or thinner is used as an inner conductor, the signal does not flow through the electrical-field-shielding layer, and since the signal flows through the outer conductor due to skin effect, the resistance component of the electrical-field-shielding layer does not generate signal loss.

In contrast, although the coaxial cable disclosed in Patent Literature 1 sets a thickness of a metal layer provided in an outer circumference of the dielectric layer in a range of 1 μm˜20 μm, there is no detailed description of the metal layer thickness, and since a thickness of 1 μm˜4 μm is required for a metal layer in order to obtain sufficient electrical characteristics solely from a metal layer made by coating and plating, it is assumable that a substantive thickness of the metal layer is 1 μm˜4 μm or thicker. Further, as described above, a thickness of the metal layer of the coaxial cable disclosed in Patent Literature 2 is thicker than 1 μm and thinner than 4 μm.

Further, the plurality of leads for outer conductors of the coaxial cable of the present disclosure is preferably formed by cross-winding.

Since the plurality of leads for outer conductors of the coaxial cable of the present disclosure are formed by cross-winding, the gauge of the coaxial cable can be reduced, when compared to a case in which the plurality of leads for outer conductors are formed by braiding. Further, the coaxial cable according to the present disclosure can have high flexibility as compared to a case that the plurality of leads for outer conductors are braided

Further, a cross-winding direction of the plurality of leads for outer conductors of the coaxial cable of the present disclosure is preferably in the same direction as a wrapping direction of the tape member.

Since the cross-winding direction of the plurality of leads for outer conductors in the coaxial cable according to the present disclosure is in the same direction as a wrapping direction of the tape member, the coaxial cable according to the present disclosure has high flexibility, and the gap between the electrical-field-shielding layer and the leads for outer conductors can be reduced.

### Effects of the Disclosure

According to the present disclosure, is possible to provide an extremely fine coaxial cable capable of reducing insertion loss so as to suppress deterioration of the transmission characteristics, even when high frequency signals are transmitted.

### BRIEF DESCRIPTION OF THE DRAWINGS

FIG. 1 (a) is a cross-sectional view which illustrates a cross section of an exemplary conventional coaxial cable taken perpendicularly to a longitudinal direction; (b) is a cross-sectional view which illustrates a cross section of the conventional coaxial cable taken perpendicularly to the longitudinal direction, when the conventional coaxial cable is made to have a diameter of an extremely fine cable; and (c) is an enlarged cross-sectional view of a dielectric layer portion of the coaxial cable shown in (b).

FIG. 2 is a cross-sectional view which illustrates a cross section of a coaxial cable according to an exemplary embodiment taken perpendicularly to a longitudinal direction.

FIG. 3 is a drawing which schematically illustrates the constants used in calculating a resistance value of an electrical-field-shielding layer.

FIG. 4 is a drawing which illustrates a relation between transmission signal frequency and return loss reduction rate.

FIG. 5 is a drawing which illustrates a relation between transmission signal frequency and insertion loss.

FIG. 6 is a drawing which illustrates a relation between a resistance value of the electrical-field-shielding layer and a reduction rate of insertion loss.

FIG. 7 is a drawing which illustrates a relation between a ratio of an outer diameter of the dielectric layer and a gauge of leads for outer conductors, and a return loss reduction rate.

### DETAILED DESCRIPTION OF THE PREFERRED EMBODIMENTS

Hereinafter, a coaxial cable according to the present disclosure will be explained with reference to the drawings. It is to be noted that the technical scope of the present disclosure is not limited to the embodiments, and extends to the equivalents of the inventions described in the claims.

Before moving forward with the explanation of the coaxial cable according to the present disclosure, the problems to be solved in a conventional cable will be described in further detail.

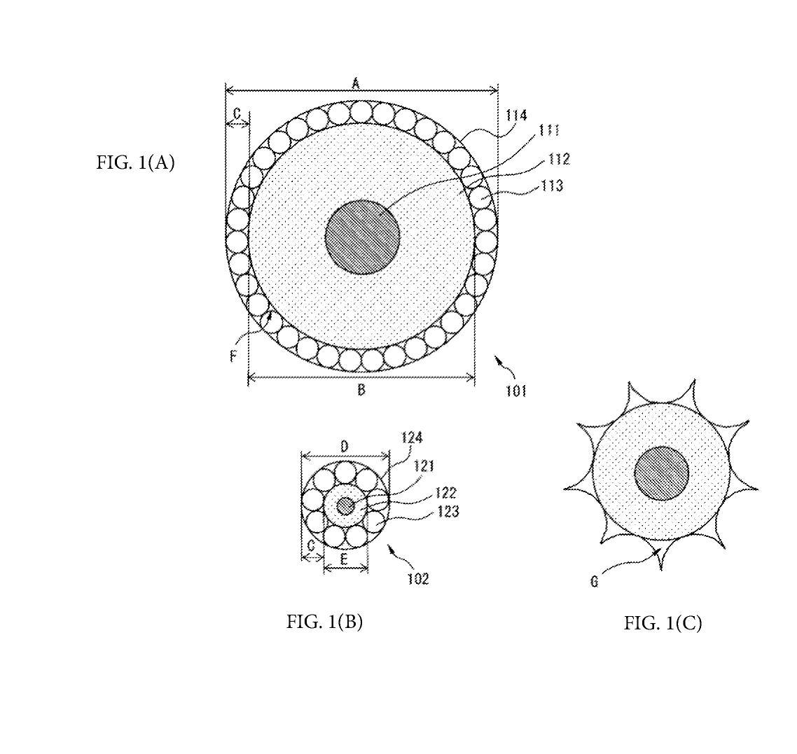

FIG. 1(a) is a cross-sectional view which illustrates a cross section of an exemplary conventional coaxial cable taken perpendicularly to a longitudinal direction; FIG. 1(b) is a cross-sectional view which illustrates a cross section of the exemplary conventional coaxial cable taken perpendicularly to the longitudinal direction, when the conventional coaxial cable is made to have a diameter of an extremely fine cable; and FIG. 1(c) is a partially enlarged cross-sectional view of the coaxial cable shown in FIG. 1(b).

A coaxial cable 101 includes an inner conductor 111; a dielectric layer 112 disposed on an outer circumferential surface of the inner conductor 111; a plurality of leads 113 for outer conductors disposed on an outer circumferential surface of the dielectric layer 112; and a sheath 114 provided to cover the plurality of leads 113 for outer conductors. The coaxial cable 101 has an exemplary structure of a conventional coaxial cable, and directly disposes the outer conductor by cross-winding, without providing a metal layer on the dielectric layer. A gauge of the coaxial cable 101 is indicated as “A,” and a gauge of the dielectric layer 112 is indicated as “B.” A gauge of the plurality of leads 113 for outer conductors are indicated as “C,” and in one example, the gauge of the plurality of leads 113 for outer conductors is 30 μm.

A coaxial cable 102 includes an inner conductor 121; a dielectric layer 122 disposed on an outer circumferential surface of the inner conductor 121; a plurality of leads 123 for outer conductors disposed on an outer circumferential surface of the dielectric layer 122; and a sheath 124 provided to cover the plurality of leads 123 for outer conductors. The coaxial cable 102 shows a structure in which the coaxial cable 101 is made to have a reduced diameter, and thereby into an extremely fine coaxial cable. The coaxial cable 102 does not include a metal layer on the dielectric layer, but directly disposes the outer conductor by cross-winding. A gauge of the coaxial cable 102 is indicated as “D,” and a gauge of the dielectric layer 122 is indicated as “E.” A diameter of the plurality of leads 123 for outer conductors is indicated as “C,” which is same as the diameter of the plurality of leads 113 for outer conductors in the coaxial cable 101.

The gauge D of the coaxial cable 102 is reduced to about one fifth of the gauge A of the coaxial cable 101. In the coaxial cable 101, and in the coaxial cable 102 having a reduced cable diameter, a conductor having substantially the same gauge is usually used in the leads for outer conductors due to manufacturing problems, or the like. In a case where a conductor having substantially the same gauge is used in the plurality of leads for outer conductors which form the outer conductor, when the gauge of the coaxial cable is big, the gap between the leads for outer conductors and the dielectric material can be ignored since the diameter of the leads for outer conductors is small enough relative to the diameter of the dielectric material, however, when the gauge of the coaxial cable is made smaller, the diameter of the dielectric material and the diameter of the leads for outer conductors become close to each other, and influence of the gap between the plurality of leads for outer conductors and the dielectric material cannot be ignored.

A proportion of a total size of the gap of the coaxial cable 101 indicated by an arrow F in FIG. 1(a) to a cross-sectional area of the dielectric layer 112 is about 2%. Meanwhile, as illustrated in the enlarged cross-sectional view of FIG. 1(c), a proportion of a total size of the gap of the coaxial cable 102 illustrated in FIG. 1(b), which is indicated by an arrow G, to a cross-sectional area of the dielectric layer 122 is about 8%. With this, in the coaxial cable 102, the proportion of the total size of the gap to the cross-sectional area of the dielectric layer is increased by four times, when compared to the coaxial cable 101.

When the diameter of the coaxial cable is extremely reduced, and thereby the proportion of the total size of the gap between the plurality of leads for outer conductor and the dielectric material to the cross-sectional area of the dielectric layer is increased, the influence of the gap between the plurality of leads for outer conductors and the dielectric layer cannot be ignored, whereby the contour of an effective dielectric material which includes the gap between the dielectric layer and the outer conductor no longer has a substantially cylindrical shape, but a distorted shape as illustrated FIG. 1(c). As a result, a problem of deterioration in the transmission characteristics of the coaxial cable occurs.

In a structure of disposing a metal layer on the dielectric layer as disclosed in Cited References 1 and 2, it is considered that the influence of the gap between the plurality of leads for outer conductors and the dielectric material can be eliminated.

However, as described above, the metal layer of the coaxial cable disclosed in Cited Reference 2 has sufficient thickness to function as a conductor, and thereby allows transmission signals to flow through the metal layer of the metal layer-attached plastic tape provided on an inner side of the outer conductor due to skin effect when high frequency signals are transmitted. Since a resistance value of the metal layer-attached plastic tape is too high to function as a conductor, the transmission signals flow through the metal layer of the metal layer-attached plastic tape, not through the outer conductor, and thereby a loss of transmission signals, which may occur due to resistance loss at the time of transmitting signals, may be increased.

When a film thickness of the metal layer of the metal layer-attached plastic tape is further increased in order to improve the loss of signal transmission in the coaxial cable having a structure as disclosed in Patent Literature 2, flexibility and durability of the coaxial cable is degraded as described above, and when the coaxial cable repeats bending motion, a crack is generated in the metal layer of the metal layer-attached plastic tape, thereby degrading the shield effect.

The inventor of the present disclosure has observed and focused on the fact that the metal layer does not function as a conductor when a resistance value of the metal layer provided between the plurality of leads for outer conductors and the dielectric material is extremely high. That is, the inventor of the present disclosure found that it is possible to suppress the reflection and the loss of transmission signals by making the metal layer provided between the plurality of leads for outer conductors and the dielectric material extremely thin, and thereby extremely increasing the resistance value, so as to inhibit the transmission signals from flowing into the metal layer.

According to the present disclosure, by setting an extremely high resistance value in the metal layer provided between the plurality of leads for outer conductors and the dielectric material to be high, the transmission signals flows through the leads for outer conductors for having low resistance value, not through the metal layer, and therefore it is possible to suppress the reflection and the loss of transmission signals, even when the transmission signals are at high frequency.

In the present disclosure, by providing an electrical-field-shielding layer between the plurality of leads for outer conductors and the dielectric layer as a metal layer having high resistance value, in which the metal layer does not function as a conductor, the contour of the effective dielectric material is corrected to a substantially cylindrical shape, and thereby it is possible to provide a coaxial cable with little reflection and little loss of transmission signals.

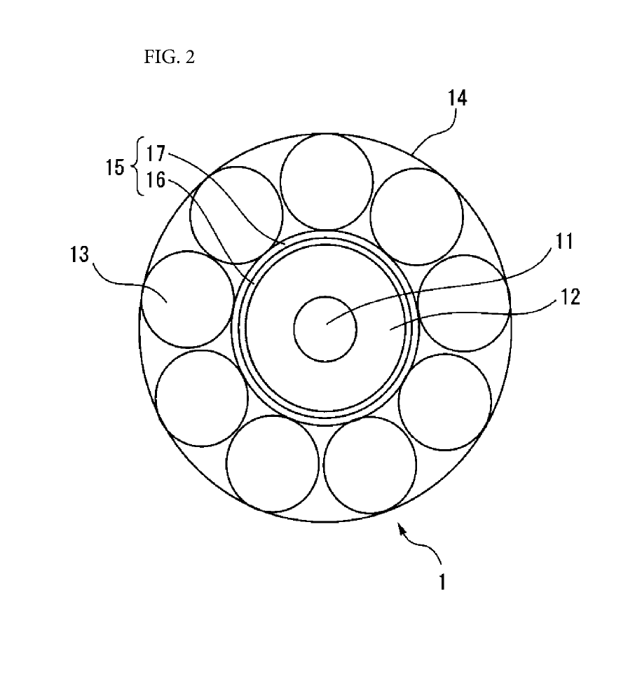

FIG. 2 is a cross-sectional view which illustrates a cross section of the coaxial cable according to an exemplary embodiment.

A coaxial cable 1 includes an inner conductor 11, a dielectric layer 12, a plurality of leads 13 for outer conductors, a sheath 14 and a tape member 15 wrapped around an outer circumferential surface of the dielectric layer 12. The tape member 15 includes a base 16 which is wrapped to contact the dielectric layer, and an electrical-field-shielding layer 17 which is disposed on the outer surface of the base 16 and of which outer circumferential surface contacts the plurality of leads 13 for outer conductors.

The inner conductor 11 includes a plurality of silver-plated copper alloy wires that are entwisted into a strand. Although it has been described that the inner conductor is formed of silver-plated copper alloy wires, it may also be formed of tin-plated copper, silver-plated copper, black copper, or the like. In one example, a gauge of the inner conductor 11 is 60 μm.

The dielectric layer 12 is formed of tetrafluoroethylene-perfluoroalkylvinylether copolymer (PFA), and provided on an outer circumferential surface of the inner conductor 11. In one example, a diameter of the dielectric layer 12 is 150 μm. The dielectric layer 12 is formed of a resin such as polythene, polytetrafluoroethylene (PTFE), fluorinated-ethylene-propylene (FEP), tetrafluoroethylene-ethylene copolymer (ETFE) or the like.

The plurality of leads 13 for outer conductors are respectively formed of silver-plated copper alloy wires, which are cross-wound in the same direction as the wrapping direction of the tape member 15, such that at least a portion of the leads 13 contacts the outer circumferential surface of the electrical-field-shielding layer 17. Each of the plurality of leads 13 for outer conductors function as a return path when transmitting signals. In one example, a gauge of each of the plurality of leads 13 for outer conductors is 30 μm. Although it has been described that the plurality of leads 13 for outer conductors are respectively formed of silver-plated copper alloy wires, they may also be formed of tin-plated copper, silver-plated copper, black copper, or the like.

The sheath 14 is formed of PFA, and is a protective film provided on an outer circumferential surface of the plurality of leads 13 for outer conductors. In one example, a thickness of the sheath 14 is 30 μm.

The base 16 is a band-shaped polyester film where an electrical-field-shielding layer is provided on one surface thereof by deposition, and is wrapped around the outer circumferential surface of the dielectric layer 12 so that the end portions in the width direction overlap, the surface provided with the electrical-field-shielding layer facing the outer side. In one example, a width of the base 16 is 0.6 mm, a thickness thereof is 4 μm, and a film thickness of the electrical-field-shielding layer 17 formed by deposition is 0.1 μm.

The electrical-field-shielding layer 17 is a metal such as aluminum, or copper, or the like formed on the one surface of the base 16 by deposition. On the outer circumferential surface of the electrical-field-shielding layer 17, the plurality of leads 13 for outer conductors are cross-wound such that at least a portion of the leads contacts the outer circumferential surface of the electrical-field-shielding layer 17. The electrical-field-shielding layer 17 is formed so that a thickness thereof is uniform throughout the entire layer, and the electrical-field-shielding layer 17 is selected to have a thickness with a resistance value of 500 Ω/m or higher where skin effect does not occur even when high frequency signals are transmitted.

The film thickness of the electrical-field-shielding layer 17 is defined as an average film thickness of the cross section of the electrical-field-shielding layer 17 in the cross section perpendicular to the longitudinal direction of the coaxial cable 1.

The resistance value of the electrical-field-shielding layer 17 is defined as a resistance per unit length, which is measured by peeling off the tape member 15 from the dielectric layer 12 to a suitable length, and then conducting an actual measurement of the resistance value of a portion between both ends of the electrical-field-shielding layer 17 provided on one surface of the opened tape member 15.

Further, the resistance value R[Ω/m] of the electrical-field-shielding layer 17 may be calculated from

R=k·ρ·L/(W₀·Mₜ).

Here, k is a coefficient which corrects the resistivity ρ[Ω/m] of the metal forming the electrical-field-shielding layer when the electrical-field-shielding layer is generated by deposition. For example, when aluminum deposition is performed, k is 2.5, and when copper deposition is performed, k is 1.25. L[m] is a length of the tape member 15 per 1 [m] of the coaxial cable 1 and is shown as

L=1·10⁻³/P. Here, 1 [mm] is a length of the tape member 15 when the tape member 15 is wrapped around the outer circumferential surface of the dielectric layer 12 once, and is shown as

l=πD/sin θ.

Here, D [mm] is a sum of a gauge Dₒ [mm] of the dielectric layer 12 and a thickness t[mm] of the tape member 15, and e is an angle when the tape member 15 is wrapped around the outer circumferential surface of the dielectric layer 12.

P [mm] is a pitch when the tape member 15 is wrapped around the outer circumferential surface of the dielectric layer 12, and is shown as

P=πD/tan θ.

Wₒ[mm] is a width of the tape member 15, and Mₜ[mm] is a thickness of the electrical-field-shielding layer 17. The width Wₒ of the tape member 15 is shown as

Wₒ=W·Wᵣ. Here, W[mm] is an effective width of the tape member 15, and is shown as

W=πD·cos θ. Wᵣ is a number of laps the tape member 15 is wound. The number of laps is 1.1˜1.3.

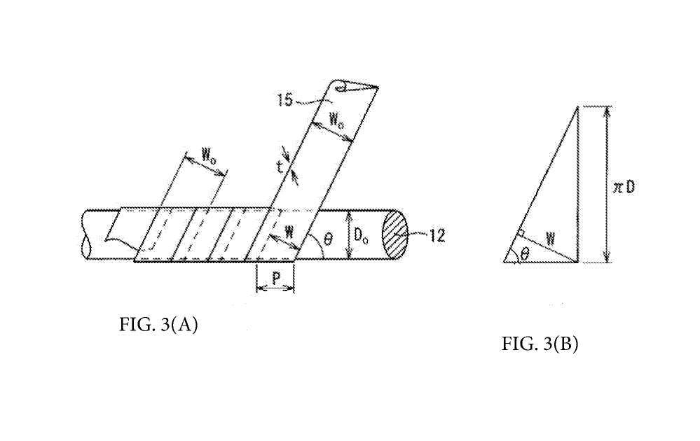

FIG. 3(a) and FIG. 3(b) are diagrams schematically illustrating the constants used when calculating the resistance value R[Ω/m] of the electrical-field-shielding layer 17.

In FIG. 3, Dₒ[mm] is the gauge of the dielectric layer 12, t[mm] is the thickness of the tape member 15, D[mm] is the sum of Dₒ and t, θ is the angle of the tape member 15 when it is wrapped around the outer circumferential surface of the dielectric layer 12, and W₀ [mm] is the width of the tape member 15. Further, W[mm] is the effective width of the tape member 15, and P[mm] is the pitch when the tape member 15 is wound around the outer circumferential surface of the dielectric layer 12.

In the coaxial cable 1, the effective dielectric material has a substantially cylindrical shape which surrounds the electrical-field-shielding layer 17 provided between the dielectric layer 12 and the plurality of leads 13 for outer conductors. In the coaxial cable 1, it is possible to suppress the reflection and the loss of transmission signals caused by the gap formed between the dielectric layer 12 and the plurality of leads 13 for outer conductors.

Furthermore, in the coaxial cable 1, since the thickness of the electrical-field-shielding layer 17 is selected to have a resistance value in which the electrical-field-shielding layer 17 does not function as a conductor, it is possible to inhibit the loss of transmission signals from increasing due to the resistance loss of transmission signals which is caused by the transmission signals flowing through the electrical-field-shielding layer 17, even when high frequency signals are transmitted.

Moreover, in the coaxial cable 1, since the plurality of leads 13 for outer conductors are cross-wound in the same direction as the wrapping direction of the tape member 15 on which the electrical-field-shielding layer 17 is provided, it is possible to reduce the gauge thereof, and have high flexibility.

A ratio between the outer diameter of the dielectric layer 12 and the gauge of the plurality of leads 13 for outer conductors is preferably within the range of 1:1˜10:1. When the gauge of the plurality of leads 13 for outer conductors becomes larger than the outer diameter of the dielectric layer 12, it is difficult to perform a uniform cross-winding of the plurality of leads 13 for outer conductors on the outer circumference of the dielectric layer 12, and for this reason, the gauge of the coaxial cable 1 is increased by increasing the gauge of the leads 13 for outer conductors.

When the outer diameter of the dielectric layer 12 is bigger than 300 μm, and the gauge of the plurality of leads 13 for outer conductors is smaller than 30 μm, the gauge of the plurality of leads 13 for outer conductors becomes smaller than one-tenth of the outer diameter of the dielectric layer 12. When the gauge of the plurality of leads 13 for outer conductors is smaller than one-tenth of the outer diameter of the dielectric layer 12, a proportion of a size of the gap formed between the plurality of leads 13 for outer conductors and the dielectric layer 12 to a cross-sectional area of the dielectric layer becomes about 2%. When the proportion of the size of the gap formed between the plurality of leads 13 for outer conductors and the dielectric layer 12 to the cross-sectional area of the dielectric layer becomes smaller than about 2%, the influence of the reflection of transmission signals caused by the gap on the transmission signals is reduced, and thereby the effect that may be anticipated by providing the electrical-field-shielding layer 17 becomes small.

Although it has been described that the plurality of leads 13 for outer conductors are cross-wound in the same direction as the wrapping direction of the tape member 15, the plurality of leads 13 for outer conductors may be cross-wound in an opposite direction to the wrapping direction of the tape member 15. Further, although it has been described that the plurality of leads 13 for outer conductors are cross-wound, the plurality of leads for outer conductors may be braided.

Further, although it has been described that the gauge of the plurality of leads 13 for outer conductors of the coaxial cable 1 is 30 μm, the gauge of the plurality of leads 13 for outer conductors may be larger than 30 μm, within a range where the flexibility of the coaxial cable 1 is not affected and the gauge of the coaxial cable 1 is not larger than necessary. Furthermore, in such a case where the dielectric material of the coaxial cable 1 is made thin, the gauge of the plurality of leads 13 for outer conductors may be smaller than 30 μm for such purpose of balancing with the diameter of the dielectric material, and suppressing the increase of the outer diameter of the dielectric material.

Further, the thickness of the electrical-field-shielding layer 17 is preferably 0.02 μm or thicker and 0.3 μm or thinner. When the thickness of the electrical-field-shielding layer 17 becomes thinner than 0.02 μm, it is difficult to manufacture the electrical-field-shielding layer having a uniform thickness, and thereby manufacturing costs can be increased. When the thickness of the electrical-field-shielding layer 17 becomes thicker than 0.3 μm, the electrical-field-shielding layer 17 functions as an outer conductor, and the loss due to the resistance loss may be increased by allowing the signals to flow through the electrical-field-shielding layer by skin effect, even when the electrical-field-shielding layer 17 is formed of metal such as iron having high resistivity.

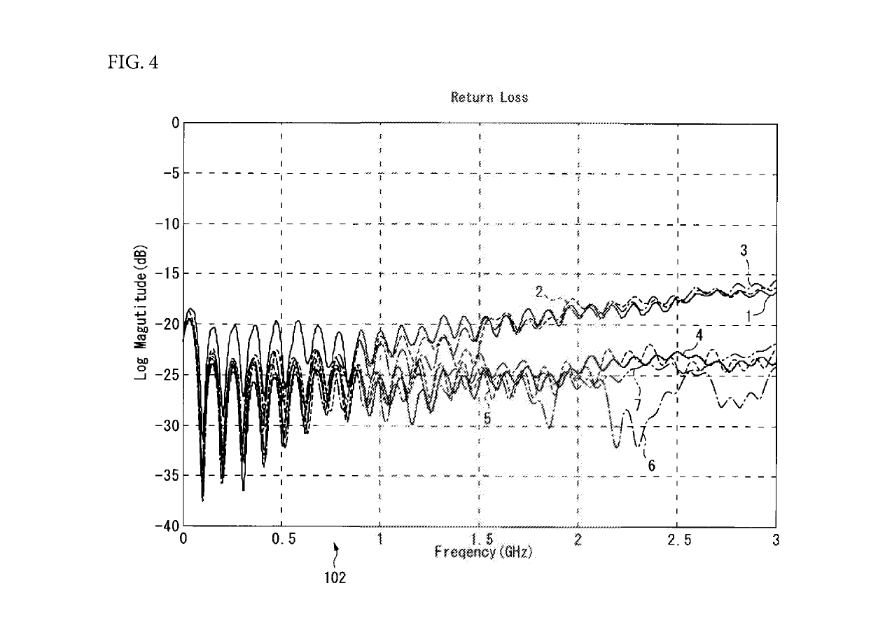

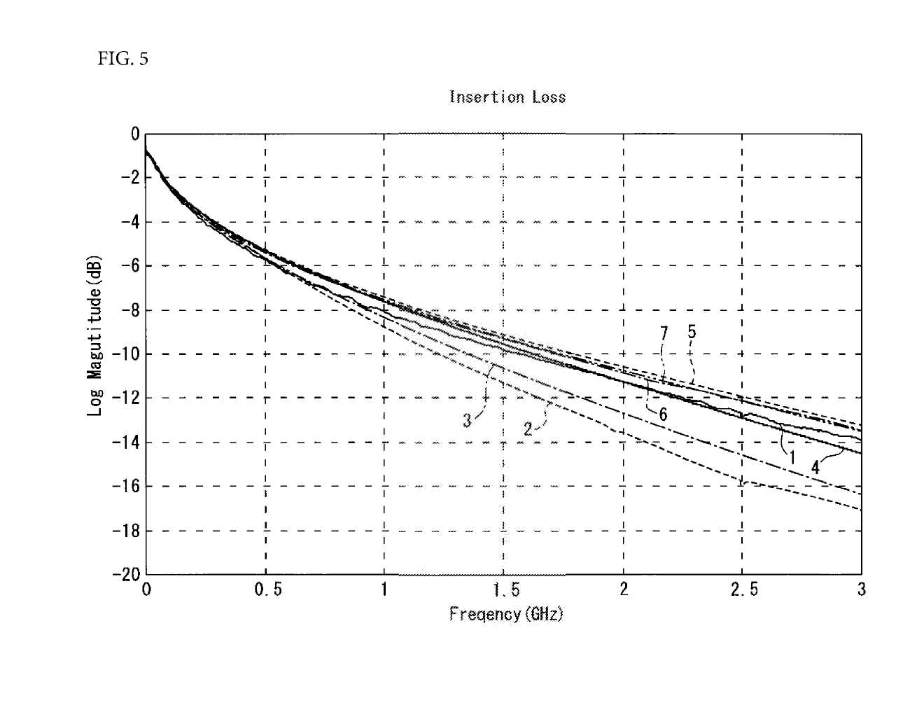

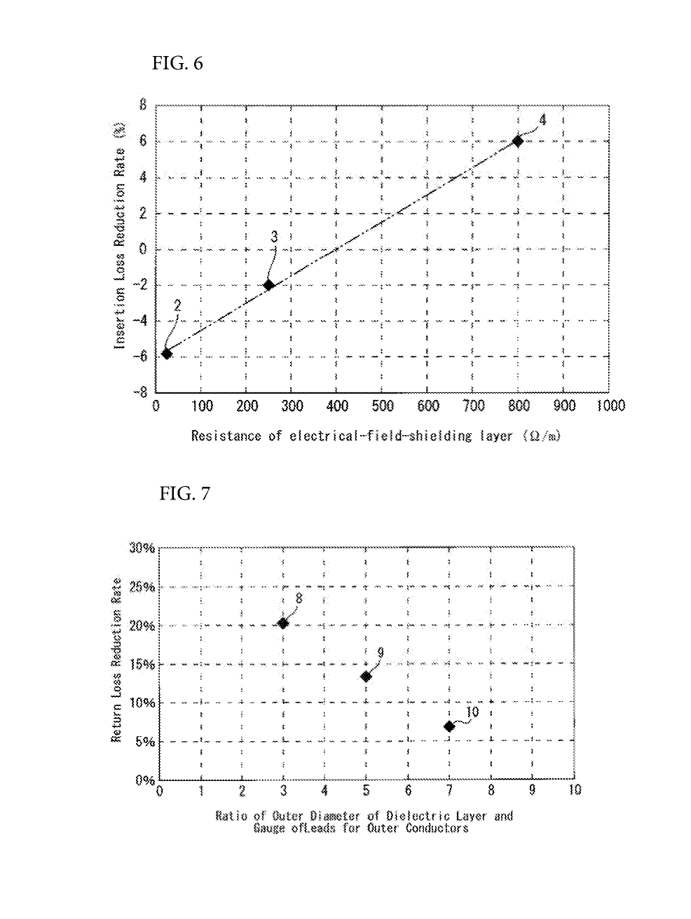

Further, the material and the thickness of the electrical-field-shielding layer 17 are preferably selected from a measured value of the return loss and the insertion loss shown in FIG. 4 and FIG. 5, and a theoretical insertion loss reduction rate shown in FIG. 6 to be 500 Ω/m or higher. When the resistance value of the electrical-field-shielding layer 17 is 500 Ω/m or higher, the return loss and the insertion loss are suppressed even when signals having a frequency of 1.5 GHz are transmitted.

Further, the material and the thickness of the electrical-field-shielding layer 17 are preferably selected so that the resistance value of the electrical-field-shielding layer 17 is 800 Ω/m or higher, as shown in FIG. 4 and FIG. 5. When the resistance value of the electrical-field-shielding layer 17 is 800 Ω/m or higher, the return loss and the insertion loss can be suppressed even when signals having a frequency of 3 GHz are transmitted.

Further, the material and the thickness of the electrical-field-shielding layer 17 are preferably selected so that the resistance value of the electrical-field-shielding layer 17 is 12,000 Ω/m or lower, as shown in FIG. 4 and FIG. 5. When the resistance value of the electrical-field-shielding layer 17 is 12,000 Ω/m or lower, the return loss and the insertion loss can be suppressed even when signals having a frequency of 1.5 GHz are transmitted.

Further, the material and the thickness of the electrical-field-shielding layer 17 are preferably selected so that the resistance value of the electrical-field-shielding layer 17 is 6,000 Ω/m or lower, as shown in FIG. 4 and FIG. 5. When the resistance value of the electrical-field-shielding layer 17 is 6,000 Ω/m or lower, the return loss and the insertion loss can be suppressed even when signals having a frequency of 3 GHz are transmitted.

Further, when aluminum is adopted as the material of the electrical-field-shielding layer 17, the thickness of the electrical-field-shielding layer 17 is preferably 0.3 mm or thinner. By setting the thickness of the electrical-field-shielding layer 17 formed of the aluminum to 0.3 mm or thinner, a conductor having a size of 38 AWG can be used as the inner conductor 11, and the resistance value of the electrical-field-shielding layer 17 can be reduced to less than 500Ω even when the tape member 15 having a width of 1.5 mm is used. Furthermore, when copper is adopted as the material of the electrical-field-shielding layer 17, the thickness of the electrical-field-shielding layer 17 is preferably 0.2 mm or thinner. By setting the thickness of the electrical-field-shielding layer 17 formed of copper to 0.2 mm or smaller, a conductor having a size of 38 AWG can be used as the inner conductor 11, and the resistance value of the electrical-field-shielding layer 17 can be reduced to less than 500Ω even when the tape member 15 having a width of 1.5 mm is used.

### Embodiment 1

The return loss and the insertion loss were measured by varying the frequency of the transmission signals of seven coaxial cables having substantially the same characteristic impedance.

In Sample 1, a silver-plated copper alloy wire having a gauge of 60 μm is used as the inner conductor, PFA having an outer diameter of 150 μm is used as the dielectric layer, and eighteen leads for outer conductors are cross-wound on the outer circumferential surface of the dielectric layer, without the intervention of the electrical-field-shielding layer. The leads for outer conductors are silver-plated copper alloy wires having a gauge of 30 μm. The sheath, which covers the leads for outer conductors, is PFA having a thickness of 30 μm.

Sample 2 is prepared by disposing an AL/PET, on which an aluminum foil having a thickness of 3 μm is adhered, between the dielectric layer and the leads for outer conductors of Sample 1, and Sample 3 is prepared by disposing a tape member, on which copper having a thickness of 0.13 μm is deposited, between the dielectric layer and the leads for outer conductors of Sample 1.

Sample 4 is prepared by disposing a tape member, on which copper having a thickness of 0.05 μm is deposited, between the dielectric layer and the leads for outer conductors of Sample 1, and Sample 5 is prepared by disposing a tape member, on which aluminum having a thickness of 0.055 μm is deposited, between the dielectric layer and the leads for outer conductors of Sample 1. Sample 6 is prepared by disposing a tape member, on which aluminum having a thickness of 0.035 μm is deposited, between the dielectric layer and the leads for outer conductors of Sample 1, and Sample 7 is prepared by disposing a tape member, on which aluminum having a thickness of 0.02 μm is deposited, between the dielectric layer and the leads for outer conductors of Sample 1.

The characteristic impedance, resistance value and thickness of deposited metal films of Sample 1˜7 are shown in Table 1.

TABLE 1

| Item | Unit | Sample 1 | Sample 2 | Sample 3 | Sample 4 | Sample 5 | Sample 6 | Sample 7 |
|---|---|---|---|---|---|---|---|---|
| Characteristic impedance | Ω | 48.2 | 49.0 | 48.5 | 48.5 | 48.5 | 48.5 | 48.5 |
| Center conductor | Ω/m | 8.6 | 8.6 | 8.6 | 8.6 | 8.6 | 8.6 | 8.6 |
| resistance | | | | | | | | |
| Shield (GND) resistance | Ω/m | 1.8 | 1.3 | 1.5 | 1.5 | 1.5 | 1.5 | 1.5 |
| Shielding layer | Ω/m | — | 25 | 280 | 800 | 3k | 6k | 12k |
| resistance | | | | | | | | |
| Shielding material layer | μm | — | 3.0 | 0.130 | 0.050 | 0.055 | 0.035 | 0.020 |
| film thickness | | | | | | | | |
| (calculated value) | | | | | | | | |
| Shielding layer material | — | — | aluminum | copper | copper | aluminum | aluminum | aluminum |

Sample 1 does not include the electrical-field-shielding layer, a resistance value of the electrical-field-shielding layer in Sample 2 is 25 Ω/m, and a resistance value of the electrical-field-shielding layer in Sample 3 is 250 Ω/m. Further, a film thickness of the electrical-field-shielding layer in Sample 2 is 3 μm, and a film thickness of the electrical-field-shielding layer in Sample 3 is 0.13 μm.

A resistance value of the electrical-field-shielding layer in Sample 4 is 800 Ω/m, a resistance value of the electrical-field-shielding layer in Sample 5 is 3 kΩ/m, a resistance value of the electrical-field-shielding layer in Sample 6 is 6 kΩ/m, and a resistance value of the electrical-field-shielding layer in Sample 7 is 12 kΩ/m. Further, a film thickness of the electrical-field-shielding layer in Sample 4 is 0.05 μm, a film thickness of the electrical-field-shielding layer in Sample 5 is 0.055 μm, a film thickness of the electrical-field-shielding layer in Sample 6 is 0.035 μm, and a film thickness of the electrical-field-shielding layer in Sample 7 is 0.02 μm.

The return loss in Samples 1˜7 were measured by a vector network analyzer.

FIG. 4 is a diagram illustrating a relation between the frequency of the transmission signals and the return loss in Samples 1˜7. In FIG. 4, the horizontal axis represents the frequency of the transmission signal, and the vertical axis represents the return loss. Further, in FIG. 4, a solid line indicated by arrow 1 shows Sample 1, a dashed line indicated by arrow 2 shows Sample 2, and a dashed dotted line indicated by arrow 3 shows Sample 3. Further, a solid line indicated by arrow 4 shows Sample 4, a dashed line indicated by arrow 5 shows Sample 5, a dashed dotted line indicated by arrow 6 illustrates Sample 6, and a dashed double-dotted line indicated by arrow 7 shows Sample 7.

When the frequency of the transmission signals is lower than 1.5 GHz, the return loss of Samples 2-7, which include an electrical-field-shielding layer, is decreased as compared to Sample 1 which does not include an electrical-field-shielding layer. When the frequency of the transmission signals exceeds 1.5 GHz, the return loss in Sample 2, which includes an electrical-field-shielding layer having a resistance value of 25 Ω/m, and the return loss in Sample 3, which includes an electrical-field-shielding layer having a resistance value of 250 Ω/m, are substantially the same as the return loss in Sample 1 which does not include an electrical-field-shielding layer. Meanwhile, when the resistance value of the electrical-field-shielding layer exceeds 800 Ω/m, the return loss in Samples 4˜7 becomes smaller than the return loss in Sample 1 which does not include an electrical-field-shielding layer, regardless of the frequency of the transmission signals.

FIG. 5 is a diagram illustrating a relation between the frequency of the transmission signals and the insertion loss in Samples 1˜7. In FIG. 5, the horizontal axis represents the frequency of the transmission signals, and the vertical axis represents the insertion loss. In FIG. 5, a solid line indicated by arrow 1 shows Sample 1, a dashed line indicated by arrow 2 shows Sample 2, and a dashed dotted line indicated by arrow 3 shows Sample 3. Further, a solid line indicated by arrow 4 shows Sample 4, a dashed line indicated by arrow 5 shows Sample 5, a dashed dotted line indicated by arrow 6 shows Sample 6, and a dashed double-dotted line indicated by arrow 7 shows Sample 7.

When the frequency of the transmission signals is lower than 1.5 GHz, the insertion loss in Sample 4, which includes an electrical-field-shielding layer having a resistance value of 800 Ω/m, is smaller than the insertion loss in Sample 1 which does not include an electrical-field-shielding layer. When the frequency of the transmission signals exceeds 1.5 GHz, the insertion loss in Sample 4 is substantially the same as the insertion loss in Sample 1 which does not include an electrical-field-shielding layer.

The insertion loss in Samples 5˜7, in which the resistance value of the electrical-field-shielding layer exceeds 3 kΩ/m, becomes smaller than the insertion loss in Sample 1 which does not include an electrical-field-shielding layer, regardless of the frequency of the transmission signals.

FIG. 6 is a diagram which shows a relation between the resistance value of the electrical-field-shielding layer and the insertion loss reduction rate in Samples 2˜4. In FIG. 6, the horizontal axis represents the resistance value of the electrical-field-shielding layer, and the vertical axis represents the insertion loss reduction rate in each Sample, relative to the insertion loss in Sample 1 which does not include an electrical-field-shielding layer. In FIG. 6, a dot indicated by reference numeral 2 shows Sample 2, a dot indicated by reference numeral 3 shows Sample 3, and a dot indicated by reference numeral 4 shows Sample 4. The insertion loss reduction rate shown in FIG. 6 is calculated based on an average value of the insertion loss at a plurality of frequencies within a frequency range lower than 1.5 GHz that was used to illustrate the graph in FIG. 6. For example, the reduction rate of the insertion loss in Sample 2 is a ratio of an average value of the insertion loss in a plurality of frequencies in Sample 2 to an average value of the insertion loss at a plurality of frequencies in Sample 1. In FIG. 6, a double-dotted dashed line is an approximate straight line calculated from the reduction rate of the insertion loss in each Sample.

In FIG. 6, when the resistance value of the electrical-field-shielding layer is higher than 400 Ω/m, the insertion loss of the transmission signals is reduced, for example, when the resistance value of the electrical-field-shielding layer is 500 Ω/m, it can be seen that the insertion loss reduction rate is about 2%.

### Embodiment 2

The return loss of transmission signals in different coaxial cables is measured, in which the ratio of the outer diameter of the dielectric layer and the gauge of the leads for outer conductors is different.

Each of the coaxial cable in Samples 8˜10 has the same configurations as in Sample 1 which does not include an electrical-field-shielding layer, except for the gauge of the leads for outer conductors. A ratio of the outer diameter of the dielectric layer and the gauge of the leads for outer conductors is 3:1 in Sample 8, a ratio of the outer diameter of the dielectric layer and the gauge of the leads for outer conductors is 5:1 in Sample 9, and a ratio of the outer diameter of the dielectric layer and the gauge of the leads for outer conductors is 7:1 in Sample 10.

FIG. 7 is a diagram illustrating the return loss reduction rate in Samples 8˜10. In FIG. 7, the horizontal axis represents the ratio of the outer diameter of the dielectric layer and the gauge of the leads for outer conductors, and the vertical axis represents the return loss reduction rate. In FIG. 7, a dot indicated by reference numeral 8 shows Sample 8, a dot indicated by reference numeral 9 shows Sample 9, and a dot indicated by reference numeral 10 shows Sample 10.

The return loss in Samples 8˜10 represent the effect of reflection waves generated in the gap formed between the dielectric layer and the leads for outer conductors. In FIG. 7, when the ratio of the outer diameter of the dielectric layer and the gauge of the leads for outer conductors is 10:1, it is assumed that the return loss of the reflection waves generated by the gap formed between the dielectric layer and the leads for outer conductors is ignored.

### DESCRIPTION OF REFERENCE NUMBERS

1, 101, 102 coaxial cable
11, 111, 121 inner conductor
12, 112, 122 dielectric layer
13, 113, 123 plurality of leads for outer conductors
14, 114, 124 sheath
15 tape member
16 base
17 electrical-field-shielding layer

1. A coaxial cable, comprising:
an inner conductor;
a dielectric layer disposed on an outer circumferential surface of the inner conductor;
a tape member having a band-shaped base and an electrical-field-shielding layer disposed on one surface of the base, the tape member being wrapped around an outer circumferential surface of the dielectric layer such that the base contacts the dielectric layer; and
a plurality of leads for outer conductors disposed such that at least a portion of the leads contacts the electrical-field-shielding layer,
wherein a resistance value of the electrical-field-shielding layer is 500 Ω/m or higher.

2. The coaxial cable of claim 1, wherein the resistance value of the electrical-field-shielding layer is 12 kΩ/m or lower.

3. The coaxial cable of claim 1, wherein a thickness of the electrical-field-shielding layer is between 0.02 μm or thicker and 0.3 μm.

4. The coaxial cable of claim 1, wherein the plurality of leads for outer conductors are cross-wound.

5. The coaxial cable of claim 4, wherein a cross-winding direction of the plurality of leads for outer conductors is the same as a wrapping direction of the tape member.

6. A coaxial cable, comprising:
an inner conductor;
a dielectric layer disposed on an outer circumferential surface of the inner conductor;
a tape member having a band-shaped base and an electrical-field-shielding layer disposed on one surface of the base, the electrical-field-shielding layer including aluminum, and the tape member being wrapped around an outer circumferential surface of the dielectric layer such that the base contacts the dielectric layer; and
a plurality of leads for outer conductors disposed such that at least a portion of the leads contacts the electrical-field-shielding layer,
wherein a film thickness of the electrical-field-shielding layer is 0.3 μm or thinner.

7. A coaxial cable, comprising:
an inner conductor;
a dielectric layer disposed on an outer circumferential surface of the inner conductor;
a tape member having a band-shaped base and an electrical-field-shielding layer disposed on one surface of the base, the electrical-field-shielding layer including copper, and the tape member being wrapped around an outer circumferential surface of the dielectric layer such that the base contacts the dielectric layer; and
a plurality of leads for outer conductors disposed such that at least a portion of the leads contacts the electrical-field-shielding layer,
wherein a film thickness of the electrical-field-shielding layer is 0.2 μm or thinner.
